(19) United States
(12) Patent Application Publication
(10) Pub. No.: US 2008/0187392 A1
(43) Pub. Date: Aug. 7, 2008

(54) CONNECTING PORTION FOR BONDING BETWEEN PARTS

(75) Inventors: Masaki Tsuchiya, Tokyo (JP); Toshitaka Sakimura, Tokyo (JP)

Correspondence Address: DARBY & DARBY P.C., P.O. BOX 770, Church Street Station, New York, NY, 10008-0770, US

(73) Assignee: SMK CORPORATION, Tokyo (JP)

(21) Appl. No.: 11/869,890

(22) Filed: Oct. 10, 2007

(30) Foreign Application Priority Data
Feb. 7, 2007 (JP) 2007-027936

(51) Int. Cl. F16B 11/00

(52) U.S. Cl. 403/268

(57) ABSTRACT

A joint for bonding parts together and preventing the overflow of an adhesive to opposite sides of a tip of an end edge part includes recesses that are formed in longitudinal directions on opposite sides of the tip of a circumferential wall part of a housing part, in the thickness directions. An abutting protruding part is protrusively provided in the longitudinal directions between the recesses. The abutting protruding part may be bonded with an adhesive, for example, to a circuit substrate. Excess portions of the adhesive that appear when bonding the abutting protruding part to the circuit substrate are stored in the recesses on opposite sides of the abutting protruding part, in the thickness directions without further overflow.

### CROSS-REFERENCE TO RELATED APPLICATION

The present application claims priority under 35 U.S.C. §119 to Japanese Patent Application No. 2007-027936, filed Feb. 7, 2007, and which is hereby incorporated herein by reference in its entirety.

### FIELD OF THE INVENTION

The present invention relates to a joint for bonding two parts together, and more particularly, a joint for bonding two parts together where one part is abutted by an end edge part of the other part with an adhesive.

### BACKGROUND OF THE INVENTION

As disclosed, for example, in Japanese Patent No. 3,813,167, which is which is incorporated herein by reference in its entirety, an imaging lens extending apparatus comprises an imaging module part, wherein an imaging sensor device is connected to a circuit substrate by a wire bonding interconnection, and has a structure wherein a pedestal is overlaid on this imaging module part at which time a circumferential wall part of a housing part at a lower part of the pedestal surrounds the imaging sensor device and an end edge part of the circumferential wall part is fixed to the circuit substrate by an adhesive.

Conventional imaging lens extending apparatuses as disclosed by Japanese Patent No. 3,813,167 have a problem wherein adhesive is coated in advance along the circuit substrate portion that is contacted by the end edge part of the circumferential wall part of the housing part, and, when the end edge part of the circumferential wall part of the housing part contacts and is bonded to the portion where the adhesive is coated, that adhesive overflows to opposite sides of a tip of the end edge part of the circumferential wall part in the thickness directions. The adhesive that overflows to the inner side of the end edge part of the circumferential wall part adheres to electronic parts and terminal patterns on the circuit substrate, which invites electrical faults. These imaging lens extending apparatuses also have a problem wherein the adhesive that overflows to the outer side of the end edge part of the circumferential wall part mars the visual appearance and subsequently peels off, which invites electrical faults.

### SUMMARY OF THE INVENTION

It is an object of the present invention to provide a joint, for example, for bonding the circuit substrate of an imaging lens extending apparatus to an end edge part of a circumferential wall part of a housing part, that can prevent the overflow of the adhesive to opposite sides of the tip of the end edge part in the thickness direction, even if one part is bonded by an adhesive to an end edge part of another part.

To solve the problems of the conventional art and to achieve the desired object as discussed above, a first aspect of the invention is a joint that bonds parts together wherein one part is abutted by an end edge part of a second part, which has a length that is the same as that the one part part, and bonded thereto with an adhesive: Recesses are formed in the longitudinal direction and on opposite sides of a tip of the end edge part in the thickness direction, such that an abutting protruding part is protrusively provided in the longitudinal direction between the recesses. Excess portions of the adhesive, which adhere the abutting protruding part to the one part, are stored in the recesses on opposite sides of the abutting protruding part in the thickness direction.

A second aspect of the invention is that the joint that bonds parts together according to the first aspect, wherein: the one part is a module part; the other part is a housing; and the end edge part is a circumferential wall part of the housing.

A third aspect of the invention is that the joint that bonds parts together according to the first aspect, wherein: the one part is an imaging module part; the other part is a housing part of a pedestal that surrounds the imaging module part; and the end edge part is the circumferential wall part of the housing part.

For a joint according to the present invention, when the one part is abutted by the end edge part, which has a length that is approximately the same as that of the other part, and is bonded thereto with the adhesive, it is possible to prevent the overflow of the adhesive away from opposite sides of the tip of the end edge part in the thickness directions because the recesses are formed in the longitudinal directions on opposite sides of the tip of the end edge part. Excess portions of the adhesive that bonds the abutting protruding part to the one part are stored in the recesses on opposite sides of the abutting protruding part in the thickness directions. The excess portions may, for example, be received from a region of the abutting contact between the abutting protruding part and the one part into the recesses when the abutting contact is made.

In one application of the present invention, the one part comprises a module part, the other part comprises a housing, and the end edge part comprises circumferential wall part of the housing. More specifically, the one part comprises an imaging module part, the other part comprises the housing part of a pedestal that surrounds the imaging module part, and the end edge part comprises a circumferential wall part of the housing part.

### BRIEF DESCRIPTION OF THE DRAWINGS

The invention will become more readily apparent from the Detailed Description of the Invention, which proceeds with reference to the drawings, in which:

FIG. 1 is an exploded oblique view of an embodiment wherein a joint that bonds parts together according to the present invention is adapted to an imaging lens extending apparatus.

FIG. 2 is a plan view of a pedestal used in embodiment of FIG. 1.

FIG. 3 is a front view of the pedestal of FIG. 2.

FIG. 4 is a cross sectional view taken along the X-X line in FIG. 2.

FIG. 5 is an enlarged view of a region D depicted in FIG. 4.

FIG. 6 is a cross sectional view of a bonding joint in the region D depicted by FIG. 5.

In the figures, elements that are repeatedly illustrated are consistently identified by a single reference numeral.

### DESCRIPTION OF THE INVENTION

The following table provides a key to the reference numerals and elements depicted in the drawings:

A Imaging module part

1 Imaging sensor device

2 Axis

3 Circuit substrate

4 Infrared filter

5 Window

6 Pedestal

6H Housing part

6Ha Circumferential wall part

7 Switching lever

8 Tubular rotary body

9 Seal ring

10 Female thread

11 Macro core

12 Imaging lens group

13 Male thread

14 Lens holder

15 Wave washer

16 Opening

17 Cover

18 filter unit

19 Corner bracket

19a Recessed part

20 Hook projection

21 Tubular guide part

22 Inclined cam surface

24 Projection

26 Rotational stop projection

27 Recessed part

28 Hookloop

30a, 30b Recessed parts

31 Abutting protruding part

32 Adhesive

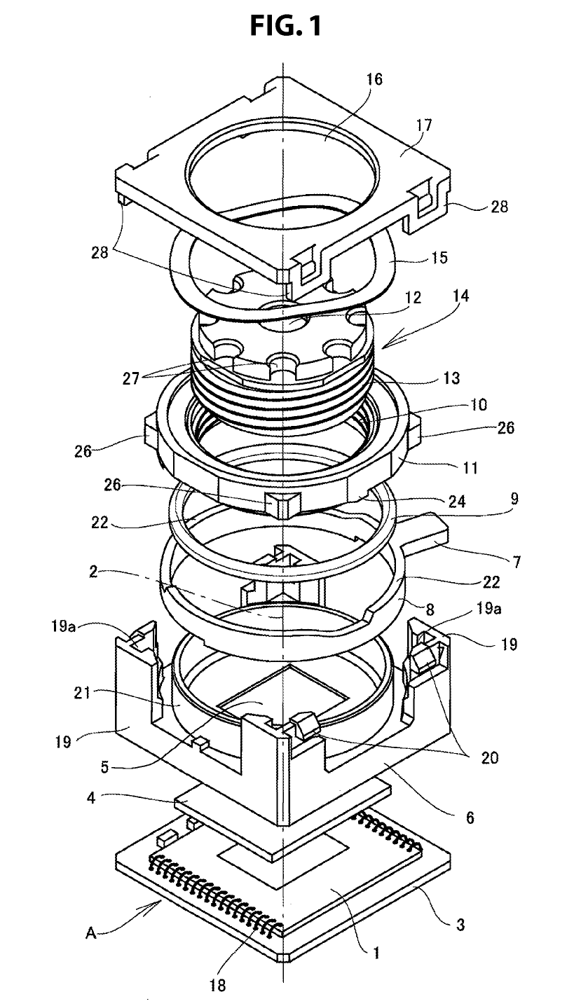

The following explains the details of a preferred embodiment of a joint that bonds parts together according to the present invention wherein the joint that bonds parts together is adapted to an imaging lens extending apparatus, referencing FIG. 1 through FIG. 6. The preferred embodiment is provided for the purpose of illustrating principles of the present invention, and should not be interpreted as further limiting the scope of the invention in any way beyond the limitations of the invention as herein claimed.

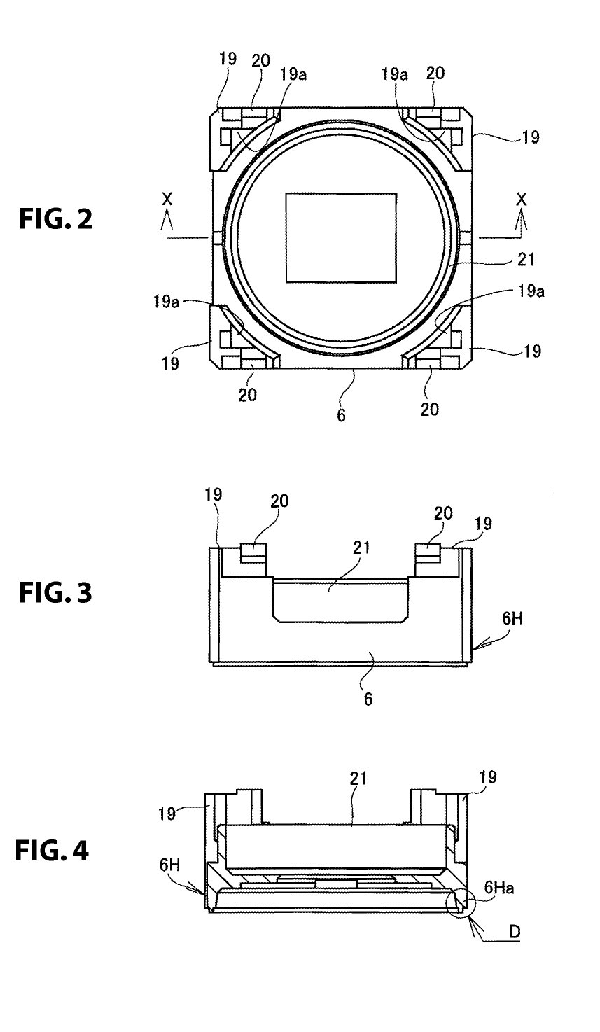

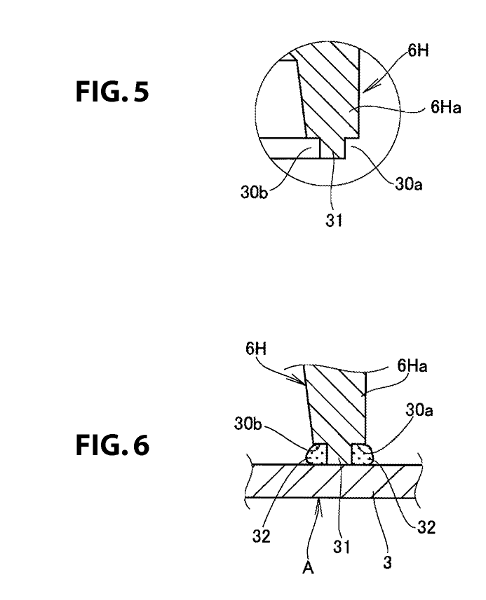

FIG. 1 is an exploded oblique view of an imaging lens extending apparatus of the present preferred embodiment. FIG. 2 presents a plan view of a pedestal used in the present embodiment, FIG. 3 presents a front view of this pedestal, and FIG. 4 is a cross sectional view taken along section X-X of the pedestal as depicted in FIG. 2. FIG. 5 provides an enlarged view of a region D depicted in FIG. 4, and FIG. 6 provides a cross sectional view of a bonding joint from the enlarged region D.

As shown in FIG. 1, the imaging lens extending apparatus of the present embodiment comprises, in an overlaid configuration: a circuit substrate 3, whereon an imaging sensor device 1 is mounted that is centered on a central vertical axis 2; an infrared filter 4; a pedestal 6, which has a window 5 that surrounds the axis 2 and that corresponds to the imaging sensor device 1, that is fixed to the circuit substrate 3; a tubular rotary body 8, which is annularly formed with a switching lever 7 that is concentric with the axis 2, that is disposed above the pedestal 6; a seal ring 9; a macro core 11, wherein a female thread 10 is provided to its inner circumferential surface; a lens holder 14 that has a built-in imaging lens group 12 and that has a male thread 13 at its outer circumference that screws into the female thread 10; an annular wave washer 15, which serves as an urging means; and a cover 17, which has an opening 16 at its center.

An imaging module part A is configured so that the circuit substrate 3 is formed as a quadrilateral upon which the quadrilateral imaging sensor device 1 is mounted, centered on the vertical axis 2 at the center of the circuit substrate 3, and then connected to the circuit substrate 3 by a wire bonding interconnection 18. The infrared filter 4 is overlaid on the imaging sensor device 1. The quadrilateral pedestal 6, which has the window 5 that surrounds the axis 2, is mounted on the circuit substrate 3. The pedestal 6 is fixed to the circuit substrate 3 by an adhesive, as discussed later. A corner bracket 19 is protrusively provided to each of the four corners of an upper surface of the pedestal 6. A hook projection 20 is protrusively provided to an outer surface of each of the corner brackets 19 on the side that correspond to one of two opposing sides of the quadrilateral pedestal 6. An annular tubular guide part 21 is protrusively provided to the upper surface of the pedestal 6 so that it is coaxial with the axis 2.

The annular tubular rotary body 8, which comprises the switching lever 7, is rotatably fit to the outer circumference of the tubular guide part 21. Multiple (three in the present embodiment) inclined cam surfaces 22 are provided successively at 120° intervals to the upper surface of the tubular rotary body 8, and the height of each in the axis 2 directions gradually changes along the circumferential direction. Each of the inclined cam surfaces 22 has a structure wherein its height in the axis 2 directions gradually increases in the counterclockwise direction in the present embodiment.

An annular groove (not shown), which is fit to a tip part of the tubular guide part 21, is provided to a lower surface of the macro core 11. Projections 24, each of which contacts a corresponding inclined cam surface 22 on the outer side of this annular groove in the radial direction, are provided to the lower surface of the macro core 11. An annular seal part, wherein the annular groove of the macro core 11 is fit via the seal ring 9, is formed at the tip part of the tubular guide part 21. The macro core 11 is configured so that the tubular guide part 21, which is fit to the annular groove thereof, functions as a guide and is slidable in the directions of the axis 2. Rotational stop projections 26 are protrusively provided to the outer circumference of the macro core 11 at 90° intervals in its outer circumferential direction. Each of these rotational stop projections 26 fits in an inward facing recessed part 19a of each of the corner brackets 19 in the four corners of the pedestal 6, and serves as a rotary stop of the macro core 11. The male thread 13 of the lens holder 14, wherein the imaging lens group 12 is built in, is screwed into and fixed to the female thread 10 on the inner circumference of the corner brackets 19. A plurality of recessed parts 27 for rotating the lens holder 14 is provided to an upper surface thereof.

The annular wave washer 15 is overlaid on the upper surface of the macro core 11, and the quadrilateral cover 17, which has an opening 16 at its center, is overlaid on the upper surface of the lens holder 14. Hook loops 28, which correspond to the hook projections 20 of the pedestal 6, are provided to the cover 17 so that they protrude downward. Each of the hook loops 28 is fit, fastened, and fixed to the corresponding hook projection 20 of the pedestal 6 by pressing the cover 17 toward the pedestal 6 side.

With the joint that bonds parts together of the present embodiment, one part is an imaging module part A, another part is a housing part 6H of the pedestal 6 that surrounds the imaging module part A, and an end edge part is a circumferential wall part 6Ha of the housing part 6H.

Recesses 30a, 30b are formed in the longitudinal directions on opposite sides of the tip of the circumferential wall part 6Ha, which serves as the end edge part that has a length the same as that of the housing part 6H that is the other part, in the thickness directions. An abutting protruding part 31 is protrusively provided in the longitudinal directions between these recesses 30a, 30b. The abutting protruding part 31 is bonded with an adhesive 32 to the circuit substrate 3 of the imaging module part A, which is the one part. The excess portions of the adhesive 32 that bonds the abutting protruding part 31 to the circuit substrate 3 are stored in the recesses 30a, 30b on opposite sides of the abutting protruding part 31 in the thickness directions.

With such an imaging lens extending apparatus, the inclined cam surfaces 22 on the tubular rotary body 8 upper surface rotate attendant with the rotation of the tubular rotary body 8 around the axis 2 due to the rotational operation of the switching lever 7. By the rotation of the inclined cam surfaces 22, each projection 24 of the macro core 11 gradually changes its position of contact with the corresponding inclined cam surface 22, the macro core 11 gradually moves in the directions of the axis 2, and the distance of the lens holder 14, which comprises the imaging lens group 12, to the imaging sensor device 1 changes.

With the imaging lens extending apparatus of the present embodiment, when the imaging module part A is abutted by the circumferential wall part 6Ha, which may for example have a length that is approximately the same as that of the housing part 6H of the pedestal 6, and bonded thereto with the adhesive 32, it is possible to prevent the overflow of the adhesive 32 to opposite sides of the tip of the circumferential wall part 6Ha in the thickness directions because the recesses 30a, 30b are provided in the longitudinal direction on opposite sides of the tip of the circumferential wall part 6Ha in the thickness direction, and the excess portions of the adhesive 32 that bonds the abutting protruding part 31, which is provided between the recesses 30a, 30b in the longitudinal direction, to the circuit substrate 3 of the imaging module part A are stored in the recesses 30a, 30b on opposite sides of the abutting protruding part 31 in the thickness direction.

The above-described embodiment described an example wherein the joint that bonds parts together of the present invention is adapted to an imaging lens extending apparatus. The present invention is not limited to the above-described embodiment, and can be adapted similarly to any other apparatus having an end edge part which has a length that is approximately the same as that of another part, abuts the other part and is bonded thereto by an adhesive.

What is claimed is:

1. A joint for bonding two parts together, wherein a first one of the two parts is abutted by an end edge part of a second one of the two parts, each one of the two parts having approximately the same length and the two parts being bonded with an adhesive, the joint comprising:
recesses formed in a longitudinal direction along opposite sides of a tip of the end edge part in a thickness direction, the recesses and tip defining an abutting protruding part protrusively provided along the longitudinal direction between the recesses;
wherein when the abutting protruding part of the end edge part is brought into abutting contact with the adhesive and the first one of the two parts, excess portions of the adhesive are stored in each of the recesses and further adhere the abutting protruding part of the second one of the two parts to the first one of the two parts.

2. The joint for bonding parts together according to claim 1, wherein
the first of the two parts comprises a module; and
the second of the two parts comprises a circumferential wall of the housing.

3. The joint for bonding parts together according to claim 1, wherein
the first one of the two parts comprises an imaging module part;
the second one of the two parts comprises a pedestal that surrounds the imaging module part; and
the end edge part of the second one of the two parts comprises the circumferential wall part of the housing part.

4. The joint for bonding parts together according to claim 1, wherein at least some of the excess portions of the adhesive are forced from a region of the abutting contact into the recesses when the abutting contact is made between the first one of the two parts and the abutting protruding part of the end edge part of the second one of the two parts.
